(19) United States
(12) Patent Application Publication
(10) Pub. No.: US 2026/0245755 A1
(43) Pub. Date: Aug. 20, 2026

(54) COEXTRUDED FUEL PELLETS AND METHODS OF MANUFACTURE THEREOF

(71) Applicant: JFoster & Associates, LLC, Idaho Falls, ID (US)

(72) Inventors: Patrick John MOO, Shelley, ID (US); John Darrell BESS, Idaho Falls, ID (US)

(21) Appl. No.: 19/054,498

(22) Filed: Feb. 14, 2025

(51) Int. Cl. G21C 21/10; G21C 3/04; G21C 3/22; G21C 21/16

(52) U.S. Cl. CPC G21C 21/10; G21C 3/048; G21C 3/22; G21C 21/16

(57) ABSTRACT

A system may obtain a first precursor material containing a nuclear fuel. A system may obtain a second precursor material. A system may coextrude the first precursor material and the second precursor material wherein the first precursor material is extruded as a first pellet material in a first region of the fuel pellet, and the second precursor material is extruded as a second pellet material in a second region of the fuel pellet contacting the first region.

### GOVERNMENT SUPPORT STATEMENT

This invention was made with government support under DE-5C0023732 and DE- SC0023935 awarded by the United States Department of Energy. The government has certain rights in the invention.

### BACKGROUND

### Background and Relevant Art

Most nuclear fuel materials include one or more of the elements of uranium and plutonium. There are, however, different types or forms of nuclear fuel materials that include such elements. For example, nuclear fuel pellets (NFPs) may be used to accommodate a variety of reactor sizes and types.

The nuclear reaction including the NFPs involves the disintegration of the nuclear fuel material into two or more fission products of lower mass number. The reaction process produces a net increase in the available free neutrons, which form the basis for a self-sustaining nuclear reaction. To control the rate of the nuclear reaction, neutron-capturing elements may be added to the nuclear fuel material to compensate for initial higher reactivity of the nuclear fuel material. Neutron-capturing elements can include a neutron capturing material (e.g., burnable absorber or burnable neutron capturing material) that has a high probability of absorbing neutrons while producing no new or additional neutrons or changing into new neutron capturing materials as a result of neutron absorption.

During a nuclear reaction, heat is generated within the NFP and, more particularly, a thermal gradient is generated within the NFP such that the greatest heat is generated in a central region (e.g., lateral and/or longitudinal center) of the NFP. However, neutron capturing materials can have a lower melting point relative to nuclear fuel materials within the NFP, which can result in the NFP softening and changing geometries as the heat increases. The combination of the NFP softening and generation of the thermal gradient contributes to deformation of the NFP. Deformation of the NFP is described as taking on an hourglass shape. The combination of hourglass shape and pellet cracking create shearing pinch points (triple points) onto the inner diameter of the fuel cladding. These pellet-cladding- mechanical-interactions (PCMI) can lead to rupture of the cladding material which serves as a barrier between the NFPs and the reactor coolant.

### BRIEF SUMMARY

In some aspects, the techniques described herein relate to a method of manufacturing a fuel pellet: obtaining a first precursor material containing a nuclear fuel; obtaining a second precursor material; and coextruding the first precursor material and the second precursor material wherein the first precursor material is extruded as a first pellet material in a first region of the fuel pellet, and the second precursor material is extruded as a second pellet material in a second region of the fuel pellet contacting the first region.

In some aspects, the techniques described herein relate to a nuclear fuel pellet including: a first pellet material containing a first nuclear fuel positioned in a first region proximate a longitudinal axis of the nuclear fuel pellet; and a second pellet material positioned in a second region around at least a radially outermost surface of the first material relative to the longitudinal axis, wherein the second region has a thickness of less than 500 micrometers.

In some aspects, the techniques described herein relate to a method of manufacturing a fuel pellet: injection molding a first precursor material containing a nuclear fuel in a first region with a longitudinal axis; coextruding a second precursor material via injection molding in a second region around at least a radially outermost surface of the first region relative to the longitudinal axis; debinding at least one of the first precursor material and the second precursor material; sintering at least one of the first precursor material and the second precursor material; and densifying at least one of the first precursor material and the second precursor material.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a side cross-sectional view of a nuclear fuel pellet (NFP), according to at least some embodiments of the present disclosure;

FIG. 2 is a side cross-sectional view of another NFP, according to at least some embodiments of the present disclosure;

FIG. 3 is a side cross-sectional view of an NFP with regions of differing geometries, according to at least some embodiments of the present disclosure;

FIG. 4 is a side cross-sectional view of a composition gradient of an NFP, according to at least some embodiments of the present disclosure;

FIG. 5 is a flowchart illustrating a method of coextruding an NFP, according to at least some embodiments of the present disclosure;

FIG. 6 is a side cross-sectional schematic of a coextrusion system, according to at least some embodiments of the present disclosure;

FIG. 7 is a side cross-sectional view of an NFP with a mandrel therethrough, according to at least some embodiments of the present disclosure;

FIG. 8 a flowchart illustrating a method of coextruding an NFP, according to at least some embodiments of the present disclosure.

### DETAILED DESCRIPTION

The present disclosure generally relates to nuclear fuel pellets and to the systems and methods for manufacturing nuclear fuel pellets. More particularly, the present disclosure relates to heterogeneous nuclear fuel pellets and to the systems and methods for manufacturing heterogeneous nuclear fuel pellets through coextrusion of pellet materials. In some embodiments, a nuclear fuel pellet (NFP) according to the present disclosure is manufactured by coextrusion in a first region containing a first material including a nuclear fuel and a second region positioned around or in contact with at least a portion of the first region, where the second region contains a second material different from the first material. In some embodiments, the second material includes the nuclear fuel in a different proportion. In some embodiments, the second material includes a different nuclear fuel. In some embodiments, the second material lacks a nuclear fuel.

An NFP may be manufactured by coextruding the second material around at least a portion of the first material. Conventional NFPs are a homogeneous composition including a nuclear fuel, a binder, breeding material, burnable neutron capturing materials, or combinations thereof. Due to the uneven distribution of fission, heat, and exhaustion of byproducts, a conventional homogenous NFP can burn incompletely or inefficiently. In some examples, a conventional NFP can distort in shape during the fission process, causing further challenges with boundary effects and control of the fission in the NFP.

In some embodiments, a heterogeneous NFP can change ratios or types of nuclear fuel or other components in the various regions of the NFP to mitigate and/or leverage the different fission rates, temperatures, and/or byproducts in the NFP while remaining compatible with existing reactors such as light-water reactors (LWRs). In contrast to conventional press power and sintering methods, the systems and methods for manufacturing NFPs described herein provide improved precision and control over the placement and distribution of different components of the NFP. In some embodiments, coextrusion of a first material and a second material allows greater precision and thinner layers than other manufacturing methods, such as conventional sintering and/or overmolding. Thinner layers can allow for more precisely controlled gradients in the heterogeneity of the NFP.

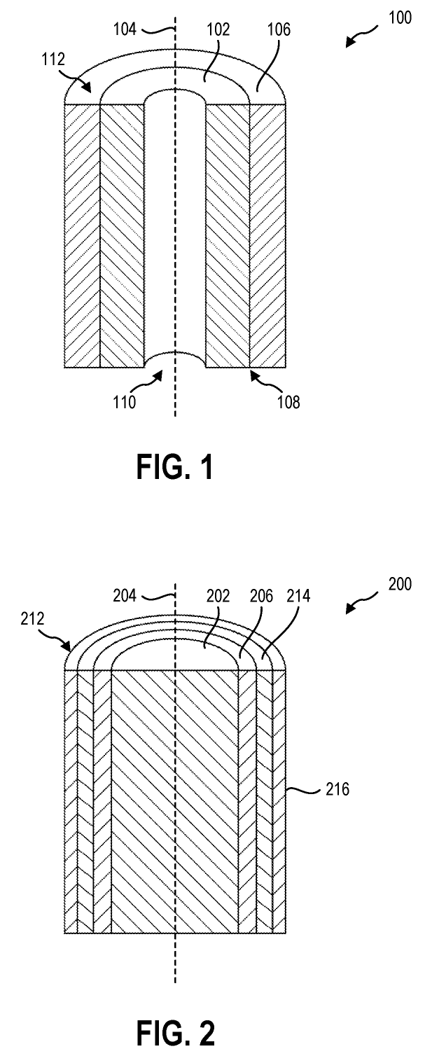

FIG. 1 is a side cross-sectional view of an NFP 100, according to some embodiments of the present disclosure. The NFP 100 is generally cylindrical with a first region 102 of a first material positioned proximate a longitudinal axis 104 of the NFP 100. A second region 106 is positioned circumferentially around the first region 102 on a radially outermost surface 108 of the first region 102. In some embodiments, the second region 106 also contacts at least a portion of the axial surface 112 of the first region 102. In some embodiments, the second region 106 is positioned around the first region 102 only in the radial direction (relative to the longitudinal axis 104). In some embodiments, the NFP 100 has a longitudinal channel or hole 110 through at least a portion thereof in the longitudinal direction. In some embodiments, the hole 110 allows exhaust of heat and/or byproducts (such as gases) during the reaction process to control the deformation of the NFP 100. In some embodiments, the hole 110 allows for capture and/or removal of heat from a region of the NFP 100 near the first material. The axial centerline is the hottest region of an NFP. Removal of material at the centerline (an annular NFP) lowers thermal gradient and related stresses.

In some embodiments, the NFP 100 has an axial surface 112 that is substantially planar. For example, the illustrated embodiment in FIG. 1 has an axial surface 112 that is planar and perpendicular to the longitudinal axis 104. In other embodiments, at least a portion of the axial surface is curved, such as concave (a dish) or convex, or has corners, such as chamfered edges, grooves, or rings as will described in greater detail herein.

FIG. 2 is a cross-sectional view of another embodiment of an NFP 200 with a solid first region 202 (e.g., lacking a hole 110 described in relation to FIG. 1) and a plurality of additional regions of different materials positioned radially outside of the first region 202. In some embodiments, the first region 202 includes a nuclear fuel, and a second region 206 positioned radially outside of the first region 202 relative to the longitudinal axis 204 includes a second material that is different from the first material. The third region 214, which is positioned radially outside of the second region 206, includes a third material that is different from the second material. In some embodiments, the third material is the same as the first material, as well. In other embodiments, the third material is different from both the first material and the second material. The fourth region 216, which is positioned radially outside of the third region 214, includes a fourth material that is different from the third material. In some embodiments, the fourth material is the same as the first material or the second material, as well. In other embodiments, the fourth material is different from both the first material and the second material, as well.

As described herein, an axial surface 212 of the NFP 200 may be non-planar in one or more directions. For example, an NFP 200 may have one or more depressed axial surfaces 212 to accommodate thermal expansion of the material closest the longitudinal axis (as the concentration of heat, and therefore thermal expansion, is greatest near the center of the NFP 200). In at least one example, an axial surface 212 of the first region 202 has a concave profile in transverse cross-section to accommodate thermal expansion of the first material. In some embodiments, the second material of the second region 206 may have a lower coefficient of thermal expansion (CTE) and/or absorb less heat during the fission reaction.

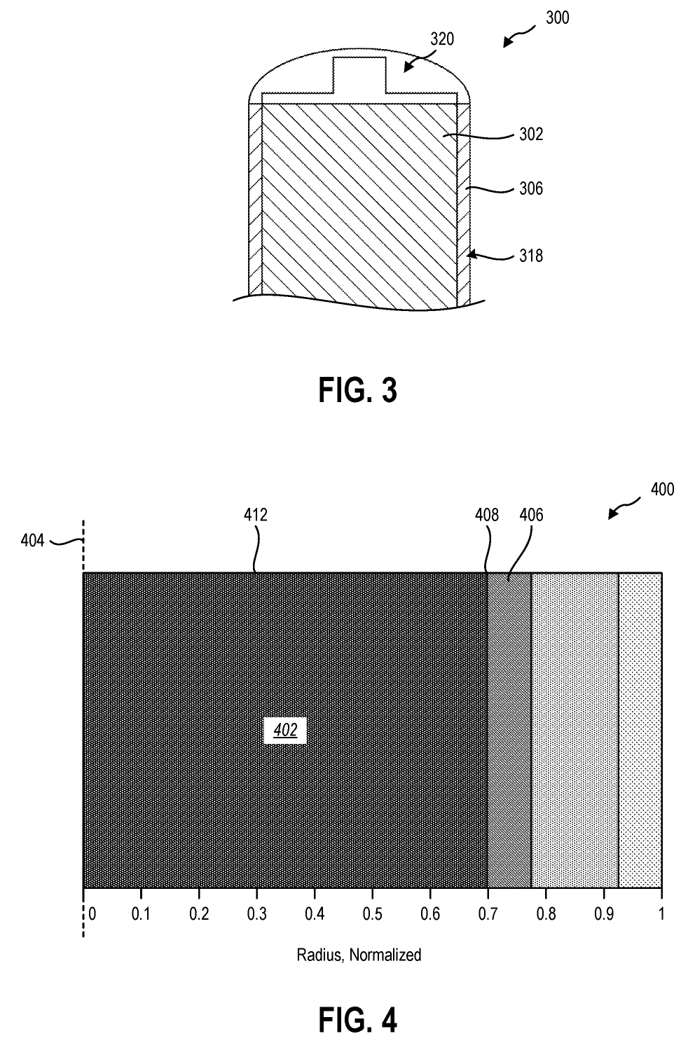

FIG. 3 is a side cross-sectional view of another example of an NFP 300 according to the present disclosure. As will be described herein, coextrusion of a plurality of materials of the NFP 300 and, in particular, coextrusion of different materials simultaneously allows for each region to have a unique geometry. In some embodiments, the radial series of materials can allow for a precise control of sustained fission through layering and relative geometry of nuclear fuel material, neutron capturing material, breeding material, inert material, etc.

For example, the first pellet material in the first region 302 may have a different composition than the second pellet material at the second region 306. In some embodiments, the first region 302 and the second region have different geometries. For example, the first region 302 may have a different cross-sectional shape and/or cross-sectional area than the second region 306. In the illustrated embodiment of FIG. 3, the first region 302 has a cruciform cross-sectional shape. In some embodiments, varying the relative cross-sectional shapes of the regions 302, 306 can control the surface area of the interface 318 between the regions 302. The shape of the interface 318 can also adjust the interaction of the nuclear fuel material, for example, in the first region, and the neutron capturing material, breeding material, inert material, etc. located in the second region 306 as energetic particles cross the interface 318.

Similarly, the NFP 300 illustrated in FIG. 3 has an open axial surface 320 wherein the first pellet material of the first region 302 and the second pellet material of the second region 306 are both exposed in a continuous geometry in the longitudinal direction of the NFP 300. In some embodiments, the NFP 300 have a closed axial surface 320 in which, for example, the first region 302 is encapsulated by the second region. For example, the second region 306 may be positioned both axially around the first region 302 and radially around the first region 302.

FIG. 4 is a radial cross-sectional view of a NFP 400 with varying material composition in each region. As described herein, in some embodiments, coextrusion of materials in layers of the NFP 400 allows for greater precision in thickness and/or boundary geometry (linearity, curvature, etc.) relative to conventional sintering processes. The more precise control enabled by the coextrusion according to the present disclosure allows, in some embodiments, a layer thickness (for example, of the second region) of less than 500 micrometers, less than 300 micrometers, less than 200 micrometers, less than 100 micrometers, less than 50 micrometers, or less than 10 micrometers. In some embodiments, the NFP 400 has a configuration for extended burnup and rim effect suppression. A primarily fissile first region 402 may include 10% enriched LEU or similar and transition second region 406 may include ²³⁸U or ²³²Th species ("Fertile"). An 'inert' material or component of a material may be ZrO2 or other non-breeding material. Other additions may include moderators such as BeO or burnable neutron capturing materials such as Gd2O3. It should be understood that the compositions described in relation to FIG. 4 are exemplary and not limiting.

Generally, the NFP 400 may include (e.g., be comprised of) any appropriate nuclear fuel material. In some embodiments, the nuclear fuel material may comprise one or more of uranium, zirconium, tungsten, rhenium, molybdenum, tantalum, iridium, uranium dioxide (UO2), uranium oxide (e.g., U308), uranium nitride (e.g., UN, U2N3, etc.), uranium silicide (e.g., U3Si2), uranium borides (e.g., UB2, UB4), a transuranic material (e.g., plutonium, plutonium oxide), minor actinides (e.g. neptunium, americium, curium), thorium, oxides thereof, another nuclear fuel material, or combinations thereof. The NFP 400 may also include (e.g., be comprised of) any appropriate additive, or dopant, material. In some embodiments, the additive material may be a neutron capturing material, such as a burnable neutron capturing material. In some embodiments, the neutron capturing material may comprise one or more of boron, gadolinium, gadolinium oxide (Gd2O3), boron carbide (B4C), another material exhibiting a high thermal neutron absorption cross-section, and combinations thereof. Other neutron capturing materials may include, molybdenum, neodymium, cadmium, erbium, hafnium, another neutron absorber, or combinations thereof.

In some embodiments, the neutron capturing material may be disposed in a region of the NFP 400 in which it will have the greatest impact on the nuclear reaction within a nuclear reactor (e.g., to enhance neutronic efficiency of the nuclear fuel material and the neutron capturing material therein) and may be excluded from other regions of the NFP 400. In some embodiments, the neutron capturing material may be excluded from a first region (e.g., a lateral and/or longitudinal center located proximate to the longitudinal axis 404) of the NFP 400 so as to inhibit deformation (e.g., hour-glassing) of the NFP 400. In other embodiments, the neutron capturing material may also be excluded from or reduced in a gradient toward the axial surfaces 412 of the NFP 400.

For example, the NFP 400 may be heterogeneous in composition across a height thereof (e.g., axially, in the longitudinal direction) and/or across a width thereof (e.g., radially from the longitudinal axis), such that amounts (e.g., concentrations) of one or more elements thereof are non-uniform within the NFP 400 and/or within one or more regions of the NFP 400. The heterogeneity of the NFP 400 and/or regions of the NFP may be substantially undetectable by visual inspection (e.g., no clear delineation of first region 402 and second regions 406), but the heterogeneity of the NFP 400 and/or regions of the NFP may be detectable by conventional spectroscopy or spectrometry techniques. A boundary between regions of different compositions within the fuel pellets may generally have a roughness at least partially defined by the microstructure of the NFP 400. Fine-grained and uniformed materials may exhibit a smoother or more uniform boundary, and coarse-grained materials may exhibit a rougher boundary. Some irregularity of the boundary may also be attributable to different particle sizes in various regions of the NFP 400.

A boundary layer is a region in which components of both neighboring regions mix and a boundary material is formed through the migration of materials. In some embodiments, a boundary layer between regions formed by coextrusion and/or injection molding is smaller (e.g., thinner in a direction normal to the boundary surface 408 between regions) than powder sintering of two powder precursors adjacent to one another. The more precise control enabled by the coextrusion and/or injection molding according to the present disclosure allows, in some embodiments, a boundary layer thickness of less than 500 micrometers, less than 300 micrometers, less than 200 micrometers, less than 100 micrometers, less than 50 micrometers, less than 10 micrometers. The exact thickness of the boundary layer is at least partially dependent on the materials in each of the neighboring regions.

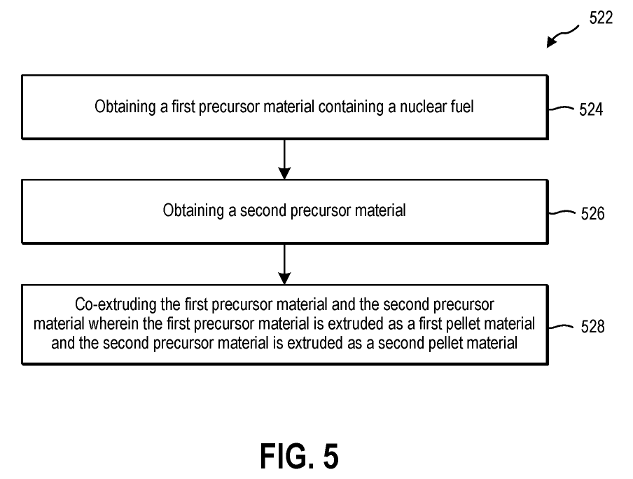

FIG. 5 is a flowchart illustrating a method 522 for manufacturing an NFP through coextrusion, according to some embodiments of the present disclosure. In some embodiments, the method 522 includes obtaining a first precursor material containing a nuclear fuel at 524 and obtaining a second precursor material at 526.

The method 522 further includes coextruding the first precursor material and the second precursor material wherein the first precursor material is extruded as a first pellet material and the second precursor material is extruded as a second pellet material at 528. In some embodiments, the first precursor material and second precursor material are extruded through a shared die. In some embodiments, the first precursor material and second precursor material are extruded through a series of dies. For example, the first precursor material may be extruded through a first die of the series of dies, and the second precursor material may be extruded through a second die of the series of dies. In some embodiments, one or more of the precursor materials changes in at least one property during the extrusion process to become the respective pellet material. For example, the first precursor material may change in density to become the first pellet material during the extrusion process. In some examples, the first precursor material includes a first phase and a second phase that react upon heating during the extrusion process to become a third phase of the first pellet material. In some embodiments, a portion of the first precursor material and a portion of the second precursor material may react during the coextrusion process (such as at or proximate to a boundary interface) to form at least a part of the first pellet material and/or second pellet material.

In some embodiments, the coextrusion at 528 is performed with a system including at least one powder injection molding (PIM) device. In some embodiments, the PIM device injects a metal matrix feedstock in a metal injection molding (MIM) process. In some embodiments, the PIM device injects a ceramic matrix feedstock in a ceramic injection molding (CIM) process. In some embodiments, the PIM device injects a ceramic-metal blend feedstock in a cermet injection molding process. For example, the feedstock of the PIM device may include cermet pellets or the feedstock may contain a mixture of ceramic-matrix pellets and metal-matrix pellets that blend in the PIM device.

In some embodiments, one or more of the precursor materials includes a binder. For example, the precursor materials may include a binder that melts or softens during the coextrusion process to allow the feedstock pellets to flow through the coextrusion system more easily and for the material being injected to flow into and/or through a die or series of dies more easily. In some embodiments, the binder is a wax binder, such as paraffin. In some embodiments, the binder is a polymer binder, such as polyethylene. In some embodiments, the precursor material(s) includes both a wax binder and a polymer binder.

Because the first pellet material, second pellet material, or additional pellet materials (such as the third pellet material, fourth pellet material, etc. described in some embodiments herein) may include binders, the NFP formed by coextrusion may, optionally, require debinding. Debinding removes the wax and/or polymer binder matrix, leaving only the original raw material (such as UO2) and may be performed through one or a combination of solvent, catalytic, or thermally driven processes. In some embodiments, the method 522 further includes debinding the coextruded NFP by exposing the NFP to an elevated temperature greater than a temperature of the first material and/or second material during PIM. In some embodiments, debinding the coextruded NFP includes debinding at a second elevated temperature after debinding at the first elevated temperature. In at least one embodiment, debinding the coextruded NFP includes exposing the NFP to a solvent while heated to the first elevated temperature and/or second elevated temperature. For example, the NFP may be heated to a first elevated temperature while exposed to heptane, acetone, or another organic solvent.

In some embodiments, the debinding can be further assisted by heating the NFP and/or exposing the NFP to a solvent in the presence of a negative ambient pressure. For example, the NFP may undergo debinding in an approximately 600 Torr ambient pressure while heated. In at least one example, the NFP is exposed to a negative ambient pressure while heated to a second elevated temperature.

The debinded NFP can then remain in the same furnace after cooldown for subsequent sintering. In some embodiments, the ambient atmosphere around the NFP in the furnace can be changed to necessary atmosphere for sintering, which may include H2 and vacuum capability to limit oxidation or other chemical changes during the sintering of the debinded NFP. In some embodiments, sintering the NFP also densiies the NFP, allowing the first material, second material, or other materials of the NFP to attain 98%, 99%, or approximately 100% of theoretical maximum density.

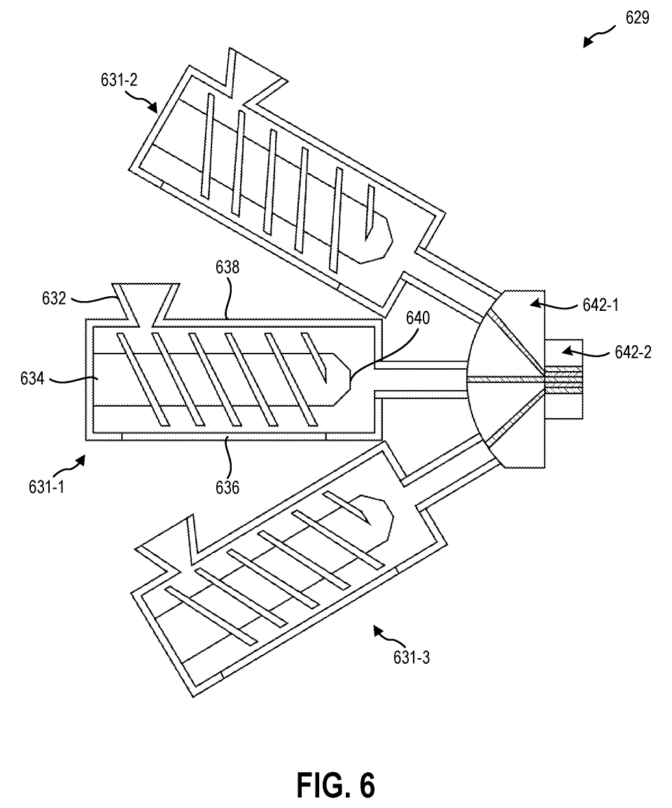

FIG. 6 is a schematic illustration of an embodiment of a coextrusion system 629. A coextrusion system 629, in some embodiments, includes a plurality of injection molding devices 631-1, 631-2, 631-3 that heat, soften, and extrude material simultaneously to extrude the materials at the same time in various geometries. For example, each of the injection molding devices, such as the power injection molding device 631-1, is configured to receive a feedstock 630 (i.e., a precursor material as described in relation to FIG. 5). In some embodiments, a feedstock 630 is loaded into a feed hopper 632 of the first injection molding device 631-1. The feedstock 630 may include a precursor material pre-mixed with binders or may include a powder of the precursor material with additional binders added to the powder. A screw or screws 634 of the first injection molding device 631-1 rotates to compound the feedstock 630 through a barrel 638. In some embodiments, a heating element 636 heats the barrel 638 and/or screw(s) 634 to soften and/or melt at least a portion of the feedstock 630. The feedstock 630 flows past the plunger 640 into the die(s) 642-1, 642-2 to form the molded part or a portion of the molded part. In some embodiments, the resulting NFP has one of plate, film, ribbon, rods of various shapes (circular, square, oval, annular, hexagonal, cruciform, star, etc.), other geometries, and combinations thereof (such as the substantially circular cross-sectional shape described in relation to FIG. 2 and/or the cruciform cross-sectional shape described in relation to FIG. 3 radially layered with a coextruded second material of a circular cross-sectional shape). In some embodiments, the coextrusion system 629 includes a series of dies 642-1, 642-2 into which the extruded materials are injected. In some embodiments, each die includes an orifice for an additional extruded material. In some embodiments, at least one die includes a plurality of channels and/or orifices to coextrude a plurality of materials.

In some embodiments, the coextrusion system 629 includes at least two injection molding devices 631-1, 631-2 that each extrude a different precursor material to create layered, coextruded different materials. In some embodiments, the coextrusion system 629 includes at least three injection molding devices 631-1, 631- 2, 631-3 that each extrude a different precursor material to create layered, coextruded different pellet materials. In some embodiments, at least two of the precursor materials are the same precursor material. In some embodiments, the coextrusion system 629 includes more than three injection molding devices 631-1, 631-2, 631-3 that each extrude a different precursor material to create layered, coextruded different materials. In some embodiments, at least two of the precursor materials are the same precursor material.

Because coextrusion and the injection molding techniques discussed herein provide a high grade of surface finish and surface quality, the NFP is removed from the die in a near-final form. In some embodiments, an NFP in near-final form requires little or no final machining to provide an NFP in final form. In some examples, the NFP, upon removal from the die, may require sintering and/or debinding but little or no final machining.

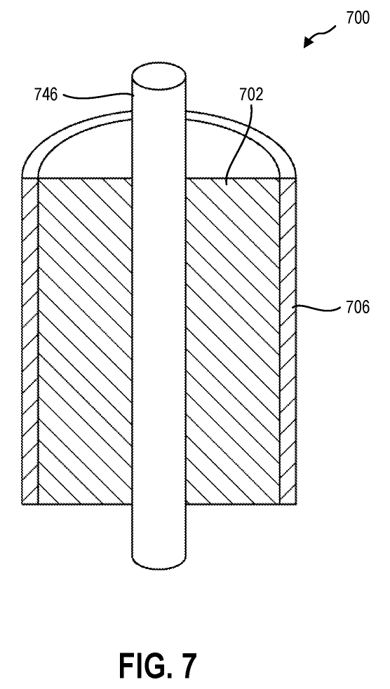

As described herein, an NFP may have a cylindrical shape, but also may have other shapes depending on the need of the reactor. For example, an NFP according to the present disclosure may be formed by PIM around a mandrel, as shown in FIG. 7. In some embodiments, the mandrel 746 can support the NFP 700 and regions thereof during the serial PIM of the first region 702, the second region 706, or more regions of different materials. In some embodiments, the mandrel 746 can be subsequently removed by heating, melting, or dissolving the mandrel 746. In other examples, a support structure or scaffolding may be used with the PIM to provide a support structure during the PIM, which is later removed. In some embodiments, the void that remains in the NFP 700 after removal of the mandrel 746 and/or other support structure may aid in heat transfer or byproduct transfer through or out of the NFP 700 .

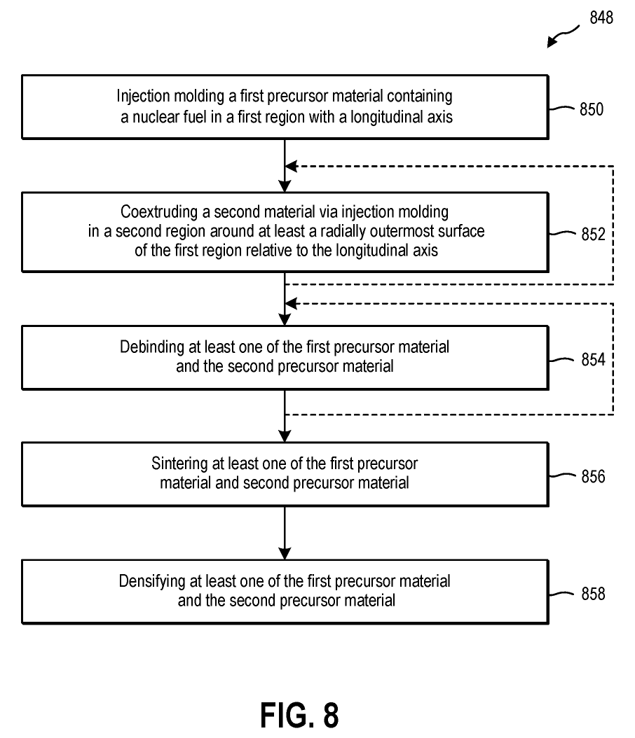

FIG. 8 is a flowchart illustrating an embodiment of a method of manufacturing an NFP according to the present disclosure. In some embodiments, the method 848 includes injection molding of a first precursor material containing a nuclear fuel through a powder injection molding device into a first die at 850. The first material is compressed through the injection molding device through the first die, where the first extruded material assumes the shape of the first die in a green state.

The method 848 further includes coextruding the second material in the second region at 852. In some embodiments, the second precursor material is compressed through the injection molding device and urged through a second die around the first material to assume the shape of the void between the first material and the second die.

In some embodiments, the coextrusion of the second material at 852 is performed with a powder injection molding (PIM) device. In some embodiments, the PIM device injects a metal matrix feedstock in a metal injection molding (MIM) process. In some embodiments, the PIM device injects a ceramic matrix feedstock in a ceramic injection molding (CIM) process. In some embodiments, the PIM device injects a ceramic-metal blend feedstock in a cermet injection molding process. For example, the feedstock of the PIM device may include cermet pellets, or the feedstock may contain a mixture of ceramic-matrix pellets and metal-matrix pellets that blend in the PIM device.

In some embodiments, the feedstock for one or more of the precursor materials injection molded into the NFP includes a binder. For example, the feedstock may include a binder that melts or softens during the PIM process to allow the feedstock pellets to flow through the PIM device more easily and for the material being injected into the die to more easily assume the form of the void in the mold. In some embodiments, the binder is a wax binder, such as paraffin. In some embodiments, the binder is a polymer binder, such as polyethylene. In some embodiments, the feedstock includes both a wax binder and a polymer binder.

Because the first material, second material, or additional materials (such as the third material, fourth material, etc. described in some embodiments herein) may include binders, the NFP formed by coextrusion may, optionally, require debinding at 854. Debinding removes the wax and/or polymer binder matrix, leaving only the original raw material (such as UO2) and may be performed through one or a combination of solvent, catalytic, or thermally driven processes. In some embodiments, the method 848 further includes debinding the coextruded NFP by exposing the NFP to an elevated temperature greater than a temperature of the first material and/or second material during PIM. In some embodiments, debinding the coextruded NFP includes debinding at a second elevated temperature after debinding at the first elevated temperature at 854. In at least one embodiment, debinding the coextruded NFP includes exposing the NFP to a solvent while heated to the first elevated temperature and/or second elevated temperature. For example, the NFP may be heated to a first elevated temperature while exposed to heptane, acetone, or another organic solvent. In another example, the NFP may be heated to a second elevated temperature while exposed to heptane, acetone, or another organic solvent.

In some embodiments, the debinding can be further assisted by heating the NFP and/or exposing the NFP to a solvent in the presence of a negative ambient pressure. For example, the NFP may undergo debinding in an approximately 600 Torr ambient pressure while heated. In at least one example, the NFP is exposed to a negative ambient pressure while heated to a second elevated temperature.

The debinded NFP can then remain in the same furnace after cooldown for subsequent sintering of at least one of the first material and the second material at 856. In some embodiments, the ambient atmosphere around the NFP in the furnace can be changed to necessary atmosphere for sintering, which may include H2 and vacuum capability to limit oxidation or other chemical changes during the sintering of the debinded NFP. In some embodiments, sintering the NFP also densiies at least one of the first material and the second material of the NFP at 858, allowing the first material, second material, or other materials of the NFP to attain 98%, 99%, or approximately 100% of theoretical maximum density. In other embodiments, densifying at least one of the first material and the second material at 858 is discrete from the sintering. For example, the sintering at 856 and the densifying at 858 may occur at different temperatures or atmospheric conditions.

### INDUSTRIAL APPLICABILITY

The present disclosure generally relates to nuclear fuel pellets and to the systems and methods for manufacturing nuclear fuel pellets. More particularly, the present disclosure relates to heterogeneous nuclear fuel pellets and to the systems and methods for manufacturing heterogeneous nuclear fuel pellets through coextrusion of pellet materials. In some embodiments, a nuclear fuel pellet (NFP) according to the present disclosure is manufactured by coextrusion in a first region containing a first material including a nuclear fuel and a second region positioned around or in contact with at least a portion of the first region, where the second region contains a second material different from the first material. In some embodiments, the second material includes the nuclear fuel in a different proportion. In some embodiments, the second material includes a different nuclear fuel. In some embodiments, the second material lacks a nuclear fuel.

An NFP may be manufactured by coextruding the second material around at least a portion of the first material. Conventional NFPs are a homogeneous composition including a nuclear fuel, a binder, breeding material, burnable neutron capturing materials, or combinations thereof. Due to the uneven distribution of fission, heat, and exhaustion of byproducts, a conventional homogenous NFP can burn incompletely or inefficiently. In some examples, a conventional NFP can distort in shape during the fission process, causing further challenges with boundary effects and control of the fission in the NFP.

In some embodiments, a heterogeneous NFP can change ratios or types of nuclear fuel or other components in the various regions of the NFP to mitigate and/or leverage the different fission rates, temperatures, and/or byproducts in the NFP while remaining compatible with existing reactors such as light-water reactors (LWRs). In contrast to conventional press power and sintering methods, the systems and methods for manufacturing NFPs described herein provide improved precision and control over the placement and distribution of different components of the NFP. In some embodiments, coextrusion of a first material and a second material allows greater precision and thinner layers than other manufacturing methods, such as conventional sintering and/or overmolding. Thinner layers can allow for more precisely controlled gradients in the heterogeneity of the NFP.

The NFP is, in some embodiments, generally cylindrical with a first region of a first material positioned proximate a longitudinal axis of the NFP. A second region is positioned circumferentially around the first region on a radially outermost surface of the first region. In some embodiments, the second region also contacts at least a portion of the axial surface of the first region. In some embodiments, the second region is positioned around the first region only in the radial direction (relative to the longitudinal axis). In some embodiments, the NFP has a longitudinal channel or hole through at least a portion thereof in the longitudinal direction. In some embodiments, the hole allows exhaust of heat and/or byproducts (such as gases) during the reaction process to control the deformation of the NFP. In some embodiments, the hole allows for capture and/or removal of heat from a region of the NFP near the first material. The axial centerline is the hottest region of an NFP. Removal of material at the centerline (an annular NFP) lowers thermal gradient and related stresses.

In some embodiments, the NFP has an axial surface that is substantially planar. In other embodiments, at least a portion of the axial surface is curved, such as concave (a dish) or convex, or has corners, such as chamfered edges, grooves, or rings as will described in greater detail herein.

In some embodiments, an NFP has a solid first region (e.g., lacking a hole) and a plurality of additional regions of different materials contacting of the first region. In some embodiments, the first region includes a nuclear fuel, and a second region positioned radially outside of the first region relative to the longitudinal axis includes a second material that is different from the first material. A third region, which is positioned radially outside of the second region, includes a third material that is different from the second material. In some embodiments, the third material is the same as the first material, as well. In other embodiments, the third material is different from both the first material and the second material. The fourth region, which is positioned radially outside of the third region, includes a fourth material that is different from the third material. In some embodiments, the fourth material is the same as the first material or the second material, as well. In other embodiments, the fourth material is different from both the first material and the second material, as well.

As described herein, an axial surface of the NFP may be non-planar in one or more directions. For example, an NFP may have one or more depressed axial surfaces to accommodate thermal expansion of the material closest the longitudinal axis (as the concentration of heat, and therefore thermal expansion, is greatest near the center of the NFP). In at least one example, an axial surface of the first region has a concave profile in transverse cross-section to accommodate thermal expansion of the first material. In some embodiments, the second material of the second region may have a lower coefficient of thermal expansion (CTE) and/or absorb less heat during the fission reaction.

As will be described herein, coextrusion of a plurality of materials of the NFP and, in particular, coextrusion of different materials simultaneously allows for each region to have a unique geometry. In some embodiments, the radial series of materials can allow for a precise control of sustained fission through layering and relative geometry of nuclear fuel material, neutron capturing material, breeding material, inert material, etc.

For example, the first pellet material in the first region may have a different composition than the second pellet material at the second region. In some embodiments, the first region and the second region have different geometries. For example, the first region may have a different cross-sectional shape and/or cross- sectional area than the second region. In some embodiments, varying the relative cross-sectional shapes of the regions can control the surface area of the interface between the regions. The shape of the interface can also adjust the interaction of the nuclear fuel material, for example, in the first region, and the neutron capturing material, breeding material, inert material, etc. located in the second region as energetic particles cross the interface.

In some embodiments, an NFP has an open axial surface wherein the first pellet material of the first region and the second pellet material of the second region are both exposed in a continuous geometry in the longitudinal direction of the NFP. In some embodiments, the NFP have a closed axial surface in which, for example, the first region is encapsulated by the second region. For example, the second region may be positioned both axially around the first region and radially around the first region.

As described herein, in some embodiments, coextrusion of materials in layers of the NFP allows for greater precision in thickness and/or boundary geometry (linearity, curvature, etc.) relative to conventional sintering processes. The more precise control enabled by the coextrusion according to the present disclosure allows, in some embodiments, a layer thickness (for example, of the second region) of less than 500 micrometers, less than 300 micrometers, less than 200 micrometers, less than 100 micrometers, less than 50 micrometers, or less than 10 micrometers. In some embodiments, the NFP has a configuration for extended burnup and rim effect suppression. A primarily fissile first region may include 10% enriched LEU or similar and transition second region may include ²³⁸U or ²³²Th species ("Fertile"). An 'inert' material or component of a material may be ZrO2 or other non-breeding material. Other additions may include moderators such as BeO or burnable neutron capturing materials such as Gd2O3.

Generally, the NFP may include (e.g., be comprised of) any appropriate nuclear fuel material. In some embodiments, the nuclear fuel material may comprise one or more of uranium, zirconium, tungsten, rhenium, molybdenum, tantalum, iridium, uranium dioxide (UO2), uranium oxide (e.g., U308), uranium nitride (e.g., UN, U2N3, etc.), uranium silicide (e.g., U3Si2), uranium borides (e.g., UB2, UB4), a transuranic material (e.g., plutonium, plutonium oxide), minor actinides (e.g. neptunium, americium, curium), thorium, oxides thereof, another nuclear fuel material, or combinations thereof. The NFP may also include (e.g., be comprised of) any appropriate additive, or dopant, material. In some embodiments, the additive material may be a neutron capturing material, such as a burnable neutron capturing material. In some embodiments, the neutron capturing material may comprise one or more of boron, gadolinium, gadolinium oxide (Gd2O3), boron carbide (B4C), another material exhibiting a high thermal neutron absorption cross-section, and combinations thereof. Other neutron capturing materials may include, molybdenum, neodymium, cadmium, erbium, hafnium, another neutron absorber, or combinations thereof.

In some embodiments, the neutron capturing material may be disposed in a region of the NFP in which it will have the greatest impact on the nuclear reaction within a nuclear reactor (e.g., to enhance neutronic efficiency of the nuclear fuel material and the neutron capturing material therein) and may be excluded from other regions of the NFP. In some embodiments, the neutron capturing material may be excluded from a first region (e.g., a lateral and/or longitudinal center located proximate to the longitudinal axis) of the NFP so as to inhibit deformation (e.g., hour- glassing) of the NFP. In other embodiments, the neutron capturing material may also be excluded from or reduced in a gradient toward the axial surfaces of the NFP.

For example, the NFP may be heterogeneous in composition across a height thereof (e.g., axially, in the longitudinal direction) and/or across a width thereof (e.g., radially from the longitudinal axis), such that amounts (e.g., concentrations) of one or more elements thereof are non-uniform within the NFP and/or within one or more regions of the NFP. The heterogeneity of the NFP and/or regions of the NFP may be substantially undetectable by visual inspection (e.g., no clear delineation of first region and second regions), but the heterogeneity of the NFP and/or regions of the NFP may be detectable by conventional spectroscopy or spectrometry techniques. A boundary between regions of different compositions within the fuel pellets may generally have a roughness at least partially defined by the microstructure of the NFP. Fine-grained and uniformed materials may exhibit a smoother or more uniform boundary, and coarse-grained materials may exhibit a rougher boundary. Some irregularity of the boundary may also be attributable to different particle sizes in various regions of the NFP.

A boundary layer is a region in which components of both neighboring regions mix and a boundary material is formed through the migration of materials. In some embodiments, a boundary layer between regions formed by coextrusion and/or injection molding is smaller (e.g., thinner in a direction normal to the boundary surface 408 between regions) than powder sintering of two powder precursors adjacent to one another. The more precise control enabled by the coextrusion and/or injection molding according to the present disclosure allows, in some embodiments, a boundary layer thickness of less than 500 micrometers, less than 300 micrometers, less than 200 micrometers, less than 100 micrometers, less than 50 micrometers, less than 10 micrometers. The exact thickness of the boundary layer is at least partially dependent on the materials in each of the neighboring regions.

In some embodiments, a method for manufacturing an NFP through coextrusion includes obtaining a first precursor material containing a nuclear fuel and obtaining a second precursor material.

The method further includes coextruding the first precursor material and the second precursor material wherein the first precursor material is extruded as a first pellet material and the second precursor material is extruded as a second pellet material. In some embodiments, the first precursor material and second precursor material are extruded through a shared die. In some embodiments, the first precursor material and second precursor material are extruded through a series of dies. For example, the first precursor material may be extruded through a first die of the series of dies, and the second precursor material may be extruded through a second die of the series of dies. In some embodiments, one or more of the precursor materials changes in at least one property during the extrusion process to become the respective pellet material. For example, the first precursor material may change in density to become the first pellet material during the extrusion process. In some examples, the first precursor material includes a first phase and a second phase that react upon heating during the extrusion process to become a third phase of the first pellet material. In some embodiments, a portion of the first precursor material and a portion of the second precursor material may react during the coextrusion process (such as at or proximate to a boundary interface) to form at least a part of the first pellet material and/or second pellet material.

In some embodiments, the coextrusion is performed with a system including at least one powder injection molding (PIM) device. In some embodiments, the PIM device injects a metal matrix feedstock in a metal injection molding (MIM) process. In some embodiments, the PIM device injects a ceramic matrix feedstock in a ceramic injection molding (CIM) process. In some embodiments, the PIM device injects a ceramic-metal blend feedstock in a cermet injection molding process. For example, the feedstock of the PIM device may include cermet pellets or the feedstock may contain a mixture of ceramic-matrix pellets and metal-matrix pellets that blend in the PIM device.

In some embodiments, one or more of the precursor materials includes a binder. For example, the precursor materials may include a binder that melts or softens during the coextrusion process to allow the feedstock pellets to flow through the coextrusion system more easily and for the material being injected to flow into and/or through a die or series of dies more easily. In some embodiments, the binder is a wax binder, such as paraffin. In some embodiments, the binder is a polymer binder, such as polyethylene. In some embodiments, the precursor material(s) includes both a wax binder and a polymer binder.

Because the first pellet material, second pellet material, or additional pellet materials (such as the third pellet material, fourth pellet material, etc. described in some embodiments herein) may include binders, the NFP formed by coextrusion may, optionally, require debinding. Debinding removes the wax and/or polymer binder matrix, leaving only the original raw material (such as UO2) and may be performed through one or a combination of solvent, catalytic, or thermally driven processes. In some embodiments, the method further includes debinding the coextruded NFP by exposing the NFP to an elevated temperature greater than a temperature of the first material and/or second material during PIM. In some embodiments, debinding the coextruded NFP includes debinding at a second elevated temperature after debinding at the first elevated temperature. In at least one embodiment, debinding the coextruded NFP includes exposing the NFP to a solvent while heated to the first elevated temperature and/or second elevated temperature. For example, the NFP may be heated to a first elevated temperature while exposed to heptane, acetone, or another organic solvent. In another example, the NFP may be heated to a second elevated temperature while exposed to heptane, acetone, or another organic solvent.

In some embodiments, the debinding can be further assisted by heating the NFP and/or exposing the NFP to a solvent in the presence of a negative ambient pressure. For example, the NFP may undergo debinding in an approximately 600 Torr ambient pressure while heated. In at least one example, the NFP is exposed to a negative ambient pressure while heated to a second elevated temperature.

The debinded NFP can then remain in the same furnace after cooldown for subsequent sintering. In some embodiments, the ambient atmosphere around the NFP in the furnace can be changed to necessary atmosphere for sintering, which may include H2 and vacuum capability to limit oxidation or other chemical changes during the sintering of the debinded NFP. In some embodiments, sintering the NFP also densifies the NFP, allowing the first material, second material, or other materials of the NFP to attain 98%, 99%, or approximately 100% of theoretical maximum density.

A coextrusion system, in some embodiments, includes a plurality of injection molding devices that heat, soften, and extrude material simultaneously to extrude the materials at the same time in various geometries. For example, each of the injection molding devices, such as the power injection molding device, is configured to receive a feedstock (i.e., a precursor material as described herein). In some embodiments, a feedstock is loaded into a feed hopper of the first injection molding device. The feedstock may include a precursor material pre-mixed with binders or may include a powder of the precursor material with additional binders added to the powder. A screw or screws of the first injection molding device rotates to compound the feedstock through a barrel. In some embodiments, a heating element heats the barrel and/or screw(s) to soften and/or melt at least a portion of the feedstock. The feedstock flows past the plunger into the die(s) to form the molded part or a portion of the molded part. In some embodiments, the resulting NFP has one of plate, film, ribbon, rods of various shapes (circular, square, oval, annular, hexagonal, cruciform, star, etc.), other geometries, and combinations thereof (such as the substantially circular cross- sectional shape described herein and/or the cruciform cross-sectional shape described herein radially layered with a coextruded second material of a circular cross-sectional shape). In some embodiments, the coextrusion system includes a series of dies into which the extruded materials are injected. In some embodiments, each die includes an orifice for an additional extruded material. In some embodiments, at least one die includes a plurality of channels and/or orifices to coextrude a plurality of materials.

In some embodiments, the coextrusion system includes at least two injection molding devices that each extrude a different precursor material to create layered, coextruded different materials. In some embodiments, the coextrusion system includes at least three injection molding devices that each extrude a different precursor material to create layered, coextruded different pellet materials. In some embodiments, at least two of the precursor materials are the same precursor material. In some embodiments, the coextrusion system includes more than three injection molding devices that each extrude a different precursor material to create layered, coextruded different materials. In some embodiments, at least two of the precursor materials are the same precursor material.

Because coextrusion and the injection molding techniques discussed herein provide a high grade of surface finish and surface quality, the NFP is removed from the die in a near-final form. In some embodiments, an NFP in near-final form requires little or no final machining to provide an NFP in final form. In some examples, the NFP, upon removal from the die, may require sintering and/or debinding but little or no final machining.

As described herein, an NFP may have a cylindrical shape, but also may have other shapes depending on the need of the reactor. For example, an NFP according to the present disclosure may be formed by PIM around a mandrel. In some embodiments, the mandrel can support the NFP and regions thereof during the serial PIM of the first region, the second region, or more regions of different materials. In some embodiments, the mandrel can be subsequently removed by heating, melting, or dissolving the mandrel. In other examples, a support structure or scaffolding may be used with the PIM to provide a support structure during the PIM, which is later removed. In some embodiments, the void that remains in the NFP after removal of the mandrel and/or other support structure may aid in heat transfer or byproduct transfer through or out of the NFP.

In some embodiments, a method of manufacturing an NFP according to the present disclosure includes injection molding of a first precursor material containing a nuclear fuel through a powder injection molding device into a first die. The first material is compressed through the injection molding device through the first die, where the first extruded material assumes the shape of the first die in a green state. The method further includes coextruding the second material in the second region. In some embodiments, the second precursor material is compressed through the injection molding device and urged through a second die around the first material to assume the shape of the void between the first material and the second die. In some embodiments, the coextrusion of the second material is performed with a powder injection molding (PIM) device. In some embodiments, the PIM device injects a metal matrix feedstock in a metal injection molding (MIM) process. In some embodiments, the PIM device injects a ceramic matrix feedstock in a ceramic injection molding (CIM) process. In some embodiments, the PIM device injects a ceramic-metal blend feedstock in a cermet injection molding process. For example, the feedstock of the PIM device may include cermet pellets, or the feedstock may contain a mixture of ceramic-matrix pellets and metal-matrix pellets that blend in the PIM device.

The method further includes coextruding the second material in the second region. In some embodiments, the second precursor material is compressed through the injection molding device and urged through a second die around the first material to assume the shape of the void between the first material and the second die.

In some embodiments, the feedstock for one or more of the precursor materials injection molded into the NFP includes a binder. For example, the feedstock may include a binder that melts or softens during the PIM process to allow the feedstock pellets to flow through the PIM device more easily and for the material being injected into the die to more easily assume the form of the void in the mold. In some embodiments, the binder is a wax binder, such as paraffin. In some embodiments, the binder is a polymer binder, such as polyethylene. In some embodiments, the feedstock includes both a wax binder and a polymer binder.

Because the first material, second material, or additional materials (such as the third material, fourth material, etc. described in some embodiments herein) may include binders, the NFP formed by coextrusion may, optionally, require debinding. Debinding removes the wax and/or polymer binder matrix, leaving only the original raw material (such as UO2) and may be performed through one or a combination of solvent, catalytic, or thermally driven processes. In some embodiments, the method further includes debinding the coextruded NFP by exposing the NFP to an elevated temperature greater than a temperature of the first material and/or second material during PIM. In some embodiments, debinding the coextruded NFP includes debinding at a second elevated temperature after debinding at the first elevated temperature. In at least one embodiment, debinding the coextruded NFP includes exposing the NFP to a solvent while heated to the first elevated temperature and/or second elevated temperature. For example, the NFP may be heated to a first elevated temperature while exposed to heptane, acetone, or another organic solvent. In another example, the NFP may be heated to a second elevated temperature while exposed to heptane, acetone, or another organic solvent.

In some embodiments, the debinding can be further assisted by heating the NFP and/or exposing the NFP to a solvent in the presence of a negative ambient pressure. For example, the NFP may undergo debinding in an approximately 600 Torr ambient pressure while heated. In at least one example, the NFP is exposed to a negative ambient pressure while heated to a second elevated temperature.

The debinded NFP can then remain in the same furnace after cooldown for subsequent sintering of at least one of the first material and the second material. In some embodiments, the ambient atmosphere around the NFP in the furnace can be changed to necessary atmosphere for sintering, which may include H2 and vacuum capability to limit oxidation or other chemical changes during the sintering of the debinded NFP. In some embodiments, sintering the NFP also densifies at least one of the first material and the second material of the NFP, allowing the first material, second material, or other materials of the NFP to attain 98%, 99%, or approximately 100% of theoretical maximum density. In other embodiments, densifying at least one of the first material and the second material is discrete from the sintering. For example, the sintering and the densifying may occur at different temperatures or atmospheric conditions.

The present disclosure relates to NFPs and systems and methods for manufacturing thereof according to at least the examples provided in the sections below:

Clause 1. A method of manufacturing a fuel pellet: obtaining a first precursor material containing a nuclear fuel; obtaining a second precursor material; and coextruding the first precursor material and the second precursor material wherein the first precursor material is extruded as a first pellet material in a first region of the fuel pellet, and the second precursor material is extruded as a second pellet material in a second region of the fuel pellet contacting the first region.

Clause 2. The method of clause 1, wherein the second region includes at least part of an axial surface of the first pellet material.

Clause 3. The method of clause 1, wherein coextruding the second precursor material includes powder injection molding the second precursor material.

Clause 4. The method of clause 1, further comprising debinding the first pellet material and the second pellet material at a first temperature.

Clause 5. The method of clause 4, wherein debinding the first pellet material and the second pellet material at a first temperature includes exposing the first pellet material and the second pellet material to a solvent.

Clause 6. The method of clause 5, wherein the solvent is heptane.

Clause 7. The method of clause 4, further comprising, after debinding the first pellet material and second pellet material at the first temperature, debinding the first pellet material and the second pellet material at a second temperature.

Clause 8. The method of clause 7, wherein debinding the first pellet material and the second pellet material at a second temperature includes exposing the first pellet material and the second pellet material to a negative ambient pressure.

Clause 9. The method of clause 1, further comprising sintering the first pellet material and the second pellet material at a sintering temperature greater than an extrusion temperature.

Clause 10. The method of clause 1, wherein the first precursor material includes the nuclear fuel and a polymer binder.

Clause 11. The method of clause 1, wherein the first precursor material includes the nuclear fuel and a wax binder.

Clause 12. The method of clause 1, wherein coextruding the second precursor material includes extruding the second precursor material through a shared die with the first precursor material.

Clause 13. The method of clause 1, wherein coextruding the second precursor material includes extruding the first precursor material through a first die in a series of dies and extruding the second precursor material through a second die in the series of dies.

Clause 14. A nuclear fuel pellet comprising: a first pellet material containing a first nuclear fuel positioned in a first region proximate a longitudinal axis of the nuclear fuel pellet; and a second pellet material positioned in a second region around at least a radially outermost surface of the first material relative to the longitudinal axis, wherein the second region has a thickness of less than 500 micrometers.

Clause 15. The nuclear fuel pellet of clause 14, wherein the first nuclear fuel includes uranium.

Clause 16. The nuclear fuel pellet of clause 14, wherein the second material includes a nuclear breeding material.

Clause 17. The nuclear fuel pellet of clause 16, wherein the nuclear breeding material includes thorium.

Clause 18. The nuclear fuel pellet of clause 14, wherein the second material includes a second nuclear fuel different from the first nuclear fuel.

Clause 19. A method of manufacturing a fuel pellet: injection molding a first precursor material containing a nuclear fuel in a first region with a longitudinal axis; coextruding a second precursor material via injection molding in a second region around at least a radially outermost surface of the first region relative to the longitudinal axis; debinding at least one of the first precursor material and the second precursor material; sintering at least one of the first precursor material and the second precursor material; and densifying at least one of the first precursor material and the second precursor material.

Clause 20. The method of clause 19, wherein the first region is located around a mandrel, and the method further comprises removing the mandrel.

The articles "a," "an," and "the" are intended to mean that there are one or more of the elements in the preceding descriptions. The terms "comprising," "including," and "having" are intended to be inclusive and mean that there may be additional elements other than the listed elements. Additionally, it should be understood that references to "one embodiment" or "an embodiment" of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are "about" or "approximately" the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.10%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional "means-plus-function" clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words 'means for' appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to "front" and "back" or "top" and "bottom" or "left" and "right" are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of manufacturing a fuel pellet:
obtaining a first precursor material containing a nuclear fuel;
obtaining a second precursor material; and
coextruding the first precursor material and the second precursor material wherein the first precursor material is extruded as a first pellet material in a first region of the fuel pellet, and the second precursor material is extruded as a second pellet material in a second region of the fuel pellet contacting the first region.

2. The method of claim 1, wherein the second region includes at least part of an axial surface of the first pellet material.

3. The method of claim 1, wherein coextruding the second precursor material includes powder injection molding the second precursor material.

4. The method of claim 1, further comprising debinding the first pellet material and the second pellet material at a first temperature.

5. The method of claim 4, wherein debinding the first pellet material and the second pellet material at a first temperature includes exposing the first pellet material and the second pellet material to a solvent.

6. The method of claim 5, wherein the solvent is heptane.

7. The method of claim 4, further comprising, after debinding the first pellet material and second pellet material at the first temperature, debinding the first pellet material and the second pellet material at a second temperature.

8. The method of claim 7, wherein debinding the first pellet material and the second pellet material at a second temperature includes exposing the first pellet material and the second pellet material to a negative ambient pressure.

9. The method of claim 1, further comprising sintering the first pellet material and the second pellet material at a sintering temperature greater than an extrusion temperature.

10. The method of claim 1, wherein the first precursor material includes the nuclear fuel and a polymer binder.

11. The method of claim 1, wherein the first precursor material includes the nuclear fuel and a wax binder.

12. The method of claim 1, wherein coextruding the second precursor material includes extruding the second precursor material through a shared die with the first precursor material.

13. The method of claim 1, wherein coextruding the second precursor material includes extruding the first precursor material through a first die in a series of dies and extruding the second precursor material through a second die in the series of dies.

14. A nuclear fuel pellet comprising:
a first pellet material containing a first nuclear fuel positioned in a first region proximate a longitudinal axis of the nuclear fuel pellet; and
a second pellet material positioned in a second region around at least a radially outermost surface of the first material relative to the longitudinal axis, wherein the second region has a thickness of less than 500 micrometers.

15. The nuclear fuel pellet of claim 14, wherein the first nuclear fuel includes uranium.

16. The nuclear fuel pellet of claim 14, wherein the second material includes a nuclear breeding material.

17. The nuclear fuel pellet of claim 16, wherein the nuclear breeding material includes thorium.

18. The nuclear fuel pellet of claim 14, wherein the second material includes a second nuclear fuel different from the first nuclear fuel.

19. A method of manufacturing a fuel pellet:
injection molding a first precursor material containing a nuclear fuel in a first region with a longitudinal axis;
coextruding a second precursor material via injection molding in a second region around at least a radially outermost surface of the first region relative to the longitudinal axis;
debinding at least one of the first precursor material and the second precursor material;
sintering at least one of the first precursor material and the second precursor material; and
densifying at least one of the first precursor material and the second precursor material.

20. The method of claim 19, wherein the first region is located around a mandrel, and the method further comprises removing the mandrel.
